(19) United States
(12) Patent Application Publication
(10) Pub. No.: US 2010/0230181 A1
(43) Pub. Date: Sep. 16, 2010

(54) INPUT DEVICE

(75) Inventor: Hideki SUZUKI, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/718,672

(22) Filed: Mar. 5, 2010

(30) Foreign Application Priority Data
Mar. 13, 2009 (JP) 2009-060775

(51) Int. Cl. G06F 3/044

(52) U.S. Cl. 178/18.06

(57) ABSTRACT

An input device includes: a first electrode which is positioned on a support side; a second electrode which is positioned on an operation side so as to face the first electrode with a distance therebetween and which moves closer to the first electrode due to an operation pressure; a first capacitance detection unit which detects a change in electrostatic capacitance from a change in potential or current of the second electrode when a human finger has been moved closer to the second electrode; and a second capacitance detection unit which detects a change in electrostatic capacitance from a change in potential or current of the first electrode when the second electrode has been moved closer to the first electrode.

### CROSS REFERENCE TO RELATED APPLICATION

The present invention contains subject matter related to and claims the benefit of Japanese Patent Application JP 2009-060775 filed in the Japanese Patent Office on Mar. 13, 2009, the entire contents of which is incorporated herein by reference.

### BACKGROUND OF THE DISCLOSURE

1. Technical Field

The present invention relates to an input device which can detect and discriminate a finger contact and a finger-pressing operation from each other using change in electrostatic capacitance.

2. Related Art

In an operation unit such as a portable apparatus, an input device of an electrostatic capacitance type is provided instead of an input device of a pressing switch type. The kind of input device is configured such that a plurality of X electrodes and a plurality of Y electrodes are insulated from each other and intersect with each other. When a finger which is a conductive body with potential which is approximately the same as the ground potential is moved close to the electrodes, the electrostatic capacitance between the X electrodes and the Y electrodes is changed, and thereby an approaching position of the finger can be detected.

Japanese Unexamined Patent Application Publication No. 2008-52620 discloses an input device in which the detection of the change in electrostatic capacitance and the detection of a switch type are used together.

The input device described in Japanese Unexamined Patent Application Publication No. 2008-52620 includes a plurality of inversion electrodes which are arranged to inversely operate, and the surface of each inversion electrode is covered with an insulation sheet. The ground electrodes are provided on the lower side of the respective inversion electrodes so as to face each other, and the inversion electrode and the ground electrode are insulated from each other.

When a human finger, which is a conductive body with potential which is approximately the same as the ground potential, comes into contact with the surface of the insulation sheet so as to be moved closer to the inversion electrode, an electrostatic capacitance is formed between the inversion electrode and the human finger, so that a detection signal obtained by the inversion electrode is changed. Therefore, it can be detected whether or not a finger has been moved closer to which of the inversion electrodes. In addition, when any inversion electrode is pressed, the inversion electrode comes into contact with the ground electrode. Therefore, it can be detected which of the inversion switches has been pushed by a switch signal electrically conducting the inversion electrode and the ground electrode.

The input device described in Japanese Unexamined Patent Application Publication No. 2008-52620 detects whether or not a finger has been moved closer to the inversion electrode by the change in electrostatic capacitance which is detected from the inversion electrode, and the detection signal representing that the inversion electrode has been pressed is obtained from the switch signal contacting the inversion electrode and the around electrode instead of the change in electrostatic capacitance.

For example, in the structure in which the inversion electrode faces the ground electrode as described in Japanese Unexamined Patent Application Publication No. 2008-52620, when both the approaching operation and the pressing operation of a finger are recognized only by the change in electrostatic capacitance which is detected from the inversion electrode, it cannot distinguish whether or not the electrostatic capacitance becomes large because an area of a finger contacting with the insulation sheet is large, or whether or not the electrostatic capacitance becomes large because the inversion electrode comes into contact with the ground electrode. For this reason, as described in Japanese Unexamined Patent Application Publication No. 2008-52620, it is necessary to separately obtain the switch signal in order to detect whether or not the inversion electrode has been pushed, and two kinds of detection circuit for detecting the electrostatic capacitance and the detection circuit for detecting the switch signal are necessary.

In addition, in the input device described in Japanese Unexamined Patent Application Publication No. 2008-52620, since the inversion electrode and the ground electrode come into contact with each other so as to obtain the switch signal even though the inversion electrode has been pressed by a non-conductive operation body other than a finger, the operation which is prompted by finger pressing and the operation which is prompted by non-conductive operation body pressing cannot be distinguished from each other.

These and other drawbacks exits.

### SUMMARY OF THE DISCLOSURE

Embodiments of the invention has been made to address the above problems according to the related art, and an advantage of some embodiments provide an input device that can detect both input states of an approaching operation of a human finger and a pressing operation by the finger only by detecting the change in electrostatic capacitance.

In addition, an advantage of some various embodiments is to provide an input device which discriminates the operation which is prompted by a finger from the operation which is prompted by a non-conductive operation body other than a finger.

According to an exemplary embodiment, there is provided an input device which includes: a first electrode which is positioned on a support side; a second electrode which is positioned on an operation side so as to face the first electrode with a distance therebetween and moves closer to the first electrode with an operation pressure; a first capacitance detection unit which detects a change in electrostatic capacitance from a change in potential or current of the second electrode when a human finger has been moved closer to the second electrode and a second capacitance detection unit which detects a change in electrostatic capacitance from a change in potential or current of the first electrode when the second electrode has been moved closer to the first electrode.

The input device according to various embodiments of the disclosure detects the change in electrostatic capacitance by the first capacitance detection unit and the second capacitance detection unit, so that it is possible to separately recognize the detection when a human finger has been moved closer from the detection and the detection when the first electrode has been pushed. Since the detection circuit can be configured to include only a circuit for detecting the change in electrostatic capacitance, the circuit configuration can be simplified.

In the input device according to various embodiments, a common capacitance detection unit may be commonly used as the first capacitance detection unit and the second capacitance detection unit, and the common capacitance detection unit may be switched by a switching unit so as to be connected to the first electrode and the second electrode.

By using, the common capacitance detection unit as described above, the circuit configuration can be simplified. Further, in the input device according to the embodiments of the disclosure, each of the first capacitance detection unit and the second capacitance detection unit may be separately provided as a capacitance detection unit.

When a human finger has been moved closer to the second electrode, a detection output of the first capacitance detection unit is changed and a detection output of the second capacitance detection unit is not substantially changed, and when the second electrode has been moved closer to the first electrode, a detection output of the first capacitance detection unit and a detection output of the second capacitance detection unit are changed together.

As described above, it is possible to separately recognize the detection when a human finger has been moved closer and the detection when the second electrode has been pushed from the detection of the first capacitance detection unit and the second capacitance detection unit.

Also, when the second electrode has been moved closer to the first electrode in a state where an operation body which is not a conductor has been moved closer to the second electrode, a difference between a detection output of the first capacitance detection unit and a detection output of the second capacitance detection unit may be not substantially changed.

In the above-mentioned configuration, since the detection outputs which are different from each other when the second electrode has been pushed by a human finger and when the second electrode has been pushed by the non-conductive operation body other than a finger, it is possible to distinguish an erroneous operation such as a case in which a foreign body other than a finger is touched thereon.

In the input device according to various embodiments, an elastic body is interposed between the first electrode and the second electrode. Also, there may be an air layer between the first electrode and the second electrode.

Various embodiments also provide an input device which includes: a first electrode which is positioned on a support side; a second electrode which is positioned on an operation side; a third electrode which is not changed in distance from the second electrode and moves closer to the first electrode when receiving an operation pressure, a first capacitance detection unit which detects change in electrostatic capacitance from change in potential or current of the second electrode when a human finger has been moved closer to the second electrode; and a second capacitance detection unit which detects change in electrostatic capacitance from change in potential or current of the first electrode or the third electrode when the third electrode has been moved closer to the first electrode.

Also the case when the second electrode has been moved closer and the case when the second electrode has been pushed are distinguished by obtaining different signals. In addition, the different signals can make it distinguish and recognize the detection in which a finger has been pushed and the detection in which a non-conductive operation body other than a finger has been pushed.

Also in this case, the elastic body may be interposed between the first electrode and the third electrode. An air layer also may be interposed between the first electrode and the third electrode.

The embodiments of the disclosure can advantageously recognize both input states when a human finger has been moved closer to an input unit and when the human finger pushes the input unit by discriminating only a change in electrostatic capacitance. Therefore, the detections of two kinds of input states can be discriminated by a comparatively simple circuit.

### BRIEF DESCRIPTION OF THE DRAWINGS

FIG. 1 is a plan view illustrating an input device according to an embodiment of the disclosure,

FIG. 2 is an expanded sectional view illustrating a cross section taken along the line II-II shown in FIG. 1,

FIG. 3 is a diagram illustrating a formed state of static capacitance and floating capacitance in each input unit,

FIGS. 4A and 4B are block diagrams illustrating electrostatic capacitance and floating capacitance, and a connection state of a capacitance detection unit,

FIG. 5 is a circuit diagram illustrating an example of a detection circuit which is provided at a capacitance detection unit,

FIG. 6A is a diagram illustrating an operation state of a detection unit, FIGS. 68, 6C and 6D are diagrams illustrating a detection output,

FIG. 7A is a diagram illustrating an operation state of a detection unit, FIGS. 7B, 7C and 7D are diagrams illustrating a detection output,

FIG. 8A is a diagram illustrating an operation state of a detection unit, FIGS. 8B, 8C and 8D are diagrams illustrating a detection output,

FIG. 9A is a diagram illustrating an operation state of a detection unit, FIGS. 9B, 9C and 9D are diagrams illustrating a detection output,

FIG. 10 is a circuit block diagram illustrating an input device according to an embodiment of the disclosure, and

FIGS. 11A and 11B are line maps illustrating a detection output of the input device according to an embodiment of the disclosure.

### DESCRIPTION OF EXEMPLARY EMBODIMENTS

The following description is intended to convey a thorough understanding of the embodiments described by providing a number of specific embodiments and details involving input devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

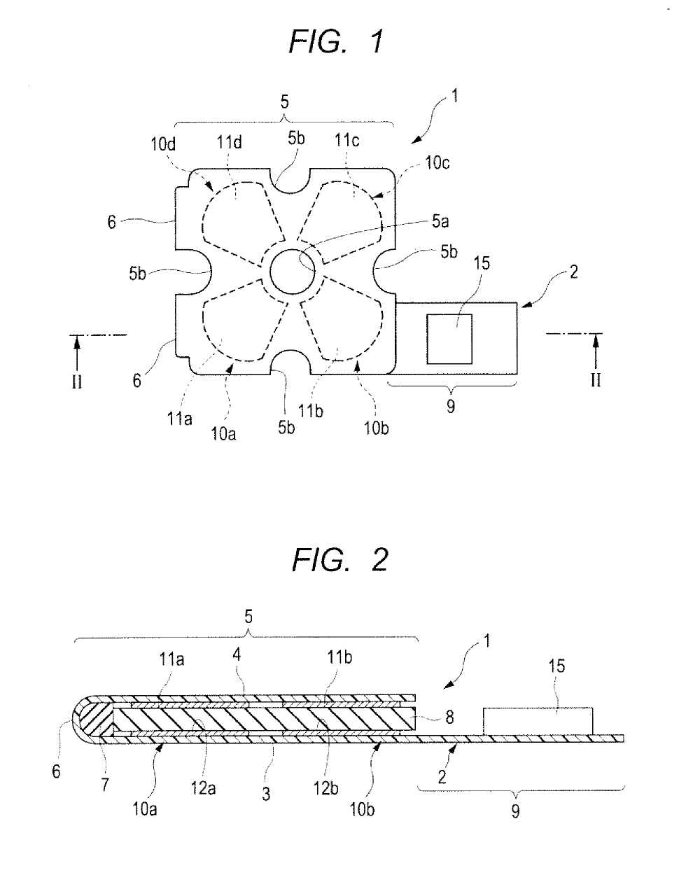

An input device 1 shown FIGS. 1 and 2 may include a flexible insulation substrate 2 which may be formed of a synthetic resin sheet or a film, for example. The insulation substrate 2 may be folded by approximately 180° in a folded portion 6 which is shown in the left side of the drawing, in which a laminated portion 5 may be configured such that an opposing sheet 3 and an opposing sheet 4 as a part of the insulation substrate 2 may vertically face each other. The laminated portion 5 may be configured such that a lower side on which the opposing sheet 3 is provided may correspond to a support side and an upper side on which the opposing sheet 4 is provided may correspond to an operation side The opposing sheet 3 on the support side may be fixed on a hard substrate. The opposing sheet 4 on the operation side may be used as a part of an operation face. In addition, the surface of the opposing sheet 4 may be covered with a flexible resin sheet on which the operation face is formed.

As shown in FIG. 1, the laminated portion 5 may be in an almost square shape, in which a circular through hole 5a may be formed on the center portion to pass through vertically and a total of four semicircular notched portions 5b which may be formed on the center portions of the respective sides thereof. In a portion in which the through hole 5a and the notched portion 5b, a switch mechanism may be provided independently of the input device 1.

As shown in FIG. 2, an elastic member 7 may be interposed inside the folded section 6. In the laminated portion 5, an elastic sheet 8 may be interposed between the opposing sheet 3 and the opposing sheet 4. The elastic sheet 8 may be provided separately from the elastic member 7 or may be formed integrally therewith.

As shown in FIG. 1, in the laminated portion 5, a first input unit 10a, a second input unit 10b, a third input unit 10c and a fourth input unit 10d may be provided in four places. In FIG. 2, the first input unit 10a and the second input unit 10b are illustrated. As shown in FIG. 2, in the first input unit 10a, a first electrode 11a may be provided on an inner surface of the opposing sheet 4 on the operation side, and a second electrode 12a may be provided on an inner surface of the opposing sheet 3 on the support side. In the second input unit 10b, a first electrode 11b may be provided on an inner surface of the opposing sheet 4, and a second electrode 12b may be provided on an inner surface of the opposing sheet 3. Similarly, a first electrode 11c and a second electrode 12c may be provided in the third input unit 10c, and a first electrode 11d and a second electrode 12d may be provided in the fourth input unit 10d.

In FIG. 1, the first electrodes 11a, 11b, 11c and 11d which are provided in the respective input units 10a, 10b, 10c and 10d are illustrated with a broken line. Each of the first electrodes 11a, 11b, 11c and 11d may be formed in a fan shape, for example, which may be disposed so as to extend in four directions perpendicular to each other about the through hole 5a. The second electrodes 12a, 12b, 12c and 12d may vertically face the first electrodes 11a, 11b, 11c and 11d with the same shape.

Each of the first electrodes 11a, 11b, 11c and 11d may be a conductive layer which may be formed on the inner surface of the opposing sheet 4. Each of the second electrodes 12a, 12b, 12c and 12d may be a conductive layer which may be formed on the inner surface of the opposing sheet 3. The conductive layers may be formed by etching a copper layer formed on the insulation substrate 2, or by printing a resin including a silver filler on the surface of the insulation substrate 2, or by printing a resin including carbon thereon. The first electrodes 11a, 11b, 11c and 11d and the elastic sheet 8 may be bonded with each other by a double-sided adhesive tape or the like. The second electrodes 12a, 12b, 12c and 12d and the elastic sheet 8 may be bonded with each other by a double-sided adhesive tape or the like.

As shown in FIGS. 1 and 2, a part of the insulation substrate 2 may be formed of an extending portion 9 which may extend from the laminated portion 5. An IC package 15 may be mounted on the surface of the extending portion 9. When the insulation substrate 2 is developed in a plane shape, the first electrodes 11a, 11b, 11c and 11d, the second electrodes 12a, 12b, 12c and 12d and the IC package 15 may be provided on the same surface as that of the insulation substrate 2. The first electrodes, the second electrodes and the IC package 15 may be electrically conducted via a conductive pattern which may be formed on the surface of the insulation substrate 2.

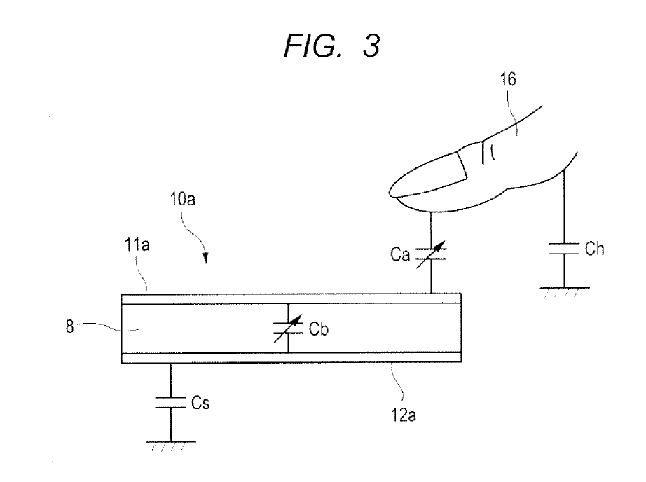

FIG. 3 shows electrostatic capacitance which may be formed in the first input unit 10a among the input units of four places. This also may be the same as the cases in the second input unit 10b, the third input unit 10c and the fourth input unit 10d.

In the first input unit 10a, variable capacitance Cb may be formed between the first electrode 11a and the second electrode 12a. The variable capacitance Cb may be varied according to a distance between the first electrode 11a and the second electrode 12a. A person is a conductive body, and a finger 16 has a potential which is approximately the same as ground potential. When the finger 16 has been moved closer to the first electrode 11a, the variable capacitance Ca may be formed between the first electrode 11a and the finger 16. The variable capacitance Ca may be varied according to a distance between the first electrode 11a and the finger 16 and a facing area between the first electrode 11a and the finger.

As shown in FIG. 3, there may be floating capacitance Cs between the second electrode 12a and a ground portion, and there also may be floating capacitance Ch between a person and the ground portion.

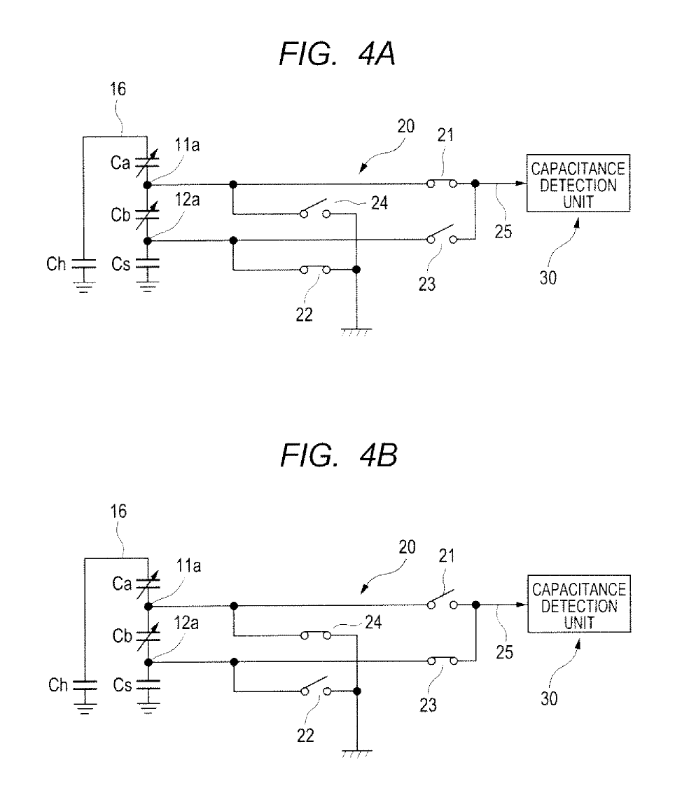

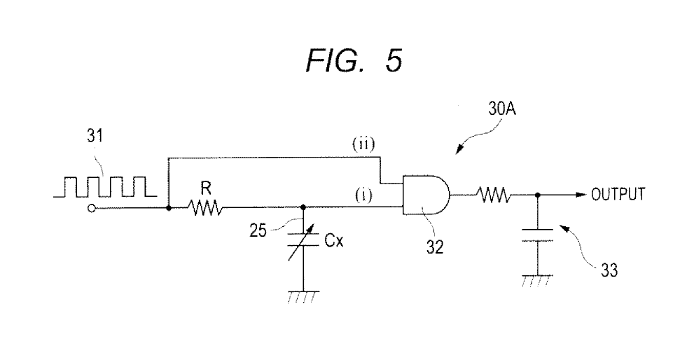

FIGS. 4 and 5 show a switching unit 20 and a capacitance detection unit 30 which may be provided inside the IC package 15.

In the input device 1, the change in electrostatic capacitance may be detected by each of the first electrode 11a and the second electrode 12a separately from each other. In an example shown in FIG. 4, by switching the circuit by the switching unit 20, the change in potential or the change in current of the first electrode 11a and the change in potential or the change in current of the second electrode 12a may be alternatively detected by one capacitance detection unit 30. That is, one capacitance detection unit 30 may be used both as the first capacitance detection unit and the second capacitance detection unit. In this case, the various embodiments may be configured to be provided with two capacitance detection units 30, so that the change in potential or the change in current of the first electrode 11a may be detected by the first capacitance detection unit and the change in potential or the change in current of the second electrode 12b may be detected by the second capacitance detection unit.

The switching unit 20 may be provided with four switches 21, 22, 23 and 24. In FIG. 4A, the switches 21 and 22 are in the ON state, the switches 23 and 24 are in the OFF state, and the first electrode 11a is connected to the capacitance detection unit 30. In FIG. 4B, the switches 21 and 22 are in the OFF state, the switches 23 and 24 are in the ON state, and the second electrode 12a is connected to the capacitance detection unit 30. The switching state shown in FIG. 4A and the switching state shown in FIG. 4B may be alternatively repeated in a cycle of short time.

In the capacitance detection unit 30, the change in electrostatic capacitance may be detected from the change in potential or the change in current of the first electrode 11a. Similarly, the change in electrostatic capacitance may be detected from the change in potential or the change in current of the second electrode 12a. The capacitance detection unit 30 may convert the change in electrostatic capacitance into the change in potential or the change in current so as to be output as a digital value or an analog value.

In FIG. 5, a detection circuit 30A is illustrated as an example of the detection circuit which may be provided in the capacitance detection unit 30. In the detection circuit 30A shown in FIG. 5, the change in each of the capacitances Ca, Cb, Cs and Ch shown in FIGS. 3 and 4 is illustrated as a variable capacitor Cx.

In the detection circuit 30A, a pulse-shaped voltage 31 of which the period is short may be applied to one electrode of the variable capacitor Cx. The pulse-shaped voltage 31 may be directly applied to an AND circuit 32. Similarly, the pulse-shaped voltage 31 may be applied to a resistor R and the electrode on the non-grounded side of the variable capacitor Cx, and further also may be applied to the AND circuit 32. The rectangular wave obtained from the AND circuit 32 may be smoothed by a smoothing circuit 33, so that a voltage or a current according to the magnitude of the electrostatic capacitance may be obtained.

When the electrostatic capacitance of the variable capacitor Cx is as close as possible to zero, there may be hardly any delay in the rising edge of the voltage (i) which may be intermittently obtained, and the voltage (i) and the voltage (ii) may become the same pulse-shaped voltage. Therefore, the output of the AND circuit 32 may become similar to the pulse-shaped voltage 31, and the voltage or the current which is smoothed by the smoothing circuit 33 may be maximized. When the electrostatic capacitance of the variable capacitor Cx is large, there may be a delay in the rising edge of the Pulse-shaped voltage (i), so that a period of time of a high level of the output of the AND circuit may be shorter than that of the pulse-shaped voltage 31. Therefore, the voltage or the current which is smoothed by the smoothing circuit 33 may become small. Furthermore, the increasing and decreasing of the voltage or the current which is obtained from the smoothing circuit 33 are inverted, so that when the electrostatic capacitance of the variable capacitor Cx becomes large, the detection output may increase, and when the electrostatic capacitance of the variable capacitor Cx becomes small, the detection output may decrease.

The capacitance detection unit 30 shown in FIG. 4 may be mounted with the detection circuit 30A shown in FIG. 5 so as to be able to obtain the detection output which may increase in accordance with the increase in variable capacitance Ca and Cb. In addition, the capacitance detection unit 30 may be mounted with a detection circuit which may be a circuit with a structure different from the detection circuit 30A and can detect the change in capacitance.

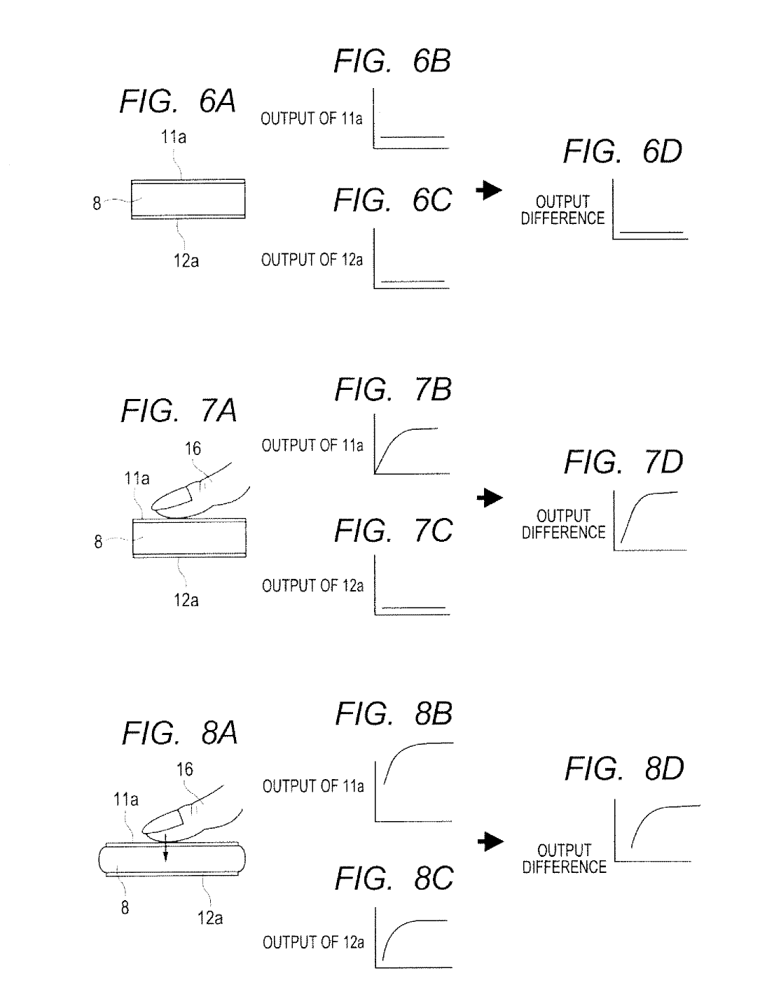

FIG. 6A illustrates a state where the finger 16 has not been moved closer to the first electrode 11a and a pressing force has not been applied on the first electrode 11a. At this time, since the variable capacitance Ca is minimized and a distance between the first electrode 11a and the second electrode 12a is maximized, the variable capacitance Cb also may be minimized.

When the switching unit 20 is switched to the state shown in FIG. 4A, the capacitance detection unit 30 may detect the electrostatic capacitance from the first electrode 11a. The detection output of the electrostatic capacitance according to the sum of the variable capacitance Ca and the variable capacitance Cb which are disposed in parallel to each other may be obtained from the first electrode 11a. When the switching unit 20 is switched to the state shown in FIG. 4B, the capacitance detection unit 30 may detect the electrostatic capacitance from the second electrode 12a. The detection output at this time may have a value based on the electrostatic capacitance of the variable capacitance Cb.

As shown in FIG. 65, when the finger 16 is not in contact, the detection output of the electrostatic capacitance which is obtained from the first electrode 11a may not be changed, and as shown in FIG. 6C, also the detection output of the electrostatic capacitance which is obtained from the second electrode 12a may not be changed. Further, as shown in FIG. 6D, in the capacitance detection unit 30, an output difference between the detection output of the electrostatic capacitance obtained from the first electrode 11a and the detection output of the electrostatic capacitance obtained from the second electrode 12a may be generated. When the finger is not in contact, the output difference also may not be changed.

FIG. 7A illustrates a state where the finger 16 has come into contact with the opposing sheet 4 and the finger 16 has been moved closer to the first electrode 11a. In this example, the first electrode 11a has not been pushed, and a distance between the first electrode 11a and the second electrode 12a may be maintained at the maximum. At this time, in order to increase the variable capacitance Ca, the detection output of the electrostatic capacitance obtained from the first electrode 11a may increase in the switching state shown in FIG. 4A. On the other hand, since the electrostatic capacitance of the variable capacitance Cb is not changed in the switching state shown in FIG. 4B, the detection output of the electrostatic capacitance obtained from the second electrode 12a may not be changed.

At this time, as shown in FIG. 7B, the detection output of the electrostatic capacitance obtained from the first electrode 11a may increase, and as shown in FIG. 7C, the detection output obtained from the second electrode 12a may not be changed. In addition, as shown in FIG. 7D, the output difference of two detection outputs may become the detection output of the electrostatic capacitance obtained from the first electrode 11a and may be increased.

FIG. 8A illustrates a state where the finger 16 has been moved closer to the first electrode 11a and the first electrode 11a has been pushed by the finger 16 so that a distance between the first electrode 11a and the second electrode 12a has been reduced. In the switched state shown in FIG. 4A, the electrostatic capacitance detected from the first electrode 11a is the sum of the variable capacitance Ca and the variable capacitance Cb which may be disposed in parallel to each other. Since both the variable capacitance Ca and the variable capacitance Cb may become large, as shown in FIG. 8B, the electrostatic capacitance detected from the first electrode 11a may become significantly larger. In addition, since also the variable capacitance Cb detected in the switched state shown in FIG. 4B, as shown in FIG. 8C, the electrostatic capacitance detected from the second electrode 12a may increase. For this reason, the output difference shown in FIG. 8D also may increase.

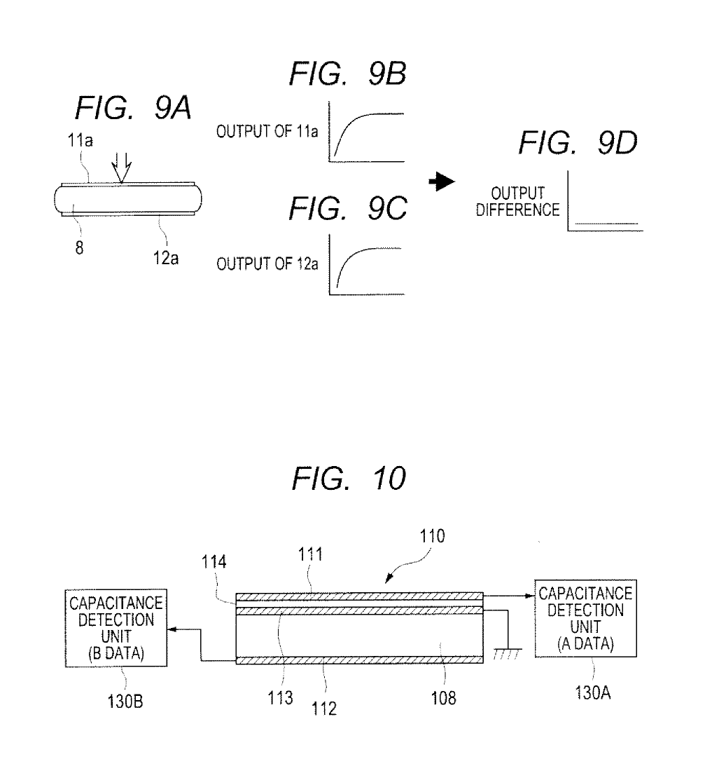

FIG. 9A illustrates a state where the first electrode 11a has been pushed by a non-conductive operation body and a distance between the first electrode 11a and the second electrode 12a has been reduced. At this time, the variable capacitance Ca may remain at the maximum, and the variable capacitance Cb may increase.

Therefore, the change in electrostatic capacitance which is obtained in the switched state shown in FIG. 4A may correspond only to the increase of the variable capacitance Cb as shown in FIG. 9B. Also the change in electrostatic capacitance which is obtained in the switched state shown in FIG. 4B may correspond only to the increase of the variable capacitance Cb as shown in FIG. 9C. Therefore, the output difference between two outputs shown in FIG. 9D may be substantially zero, and may be less than a predetermined threshold value.

When the capacitance change detected by the capacitance detection unit 30 is applied to a controller, the controller may monitor the change in electrostatic capacitance which may be detected from the first electrode 11a in the switched state shown in FIG. 4A. In addition, the controller may monitor the change in electrostatic capacitance which may be detected from the second electrode 12a in the switched state shown in FIG. 4B. Furthermore, a difference between two detection outputs as shown in FIG. 6D is monitored.

As shown in FIGS. 6 to 8, if the electrostatic capacitance detected by the first electrode 11a increases (or decreases according to a circuit) in the switched state shown in FIG. 4A, it may be determined that a human finger has come into contact with the surface of the opposing sheet 4 or the operation surface covering the opposing sheet 4. In addition, if the electrostatic capacitance detected by the second electrode 12a increases (or decreases according to a circuit) in the switched state shown in FIG. 4B, it may be determined that the surface of the opposing sheet 4 or the operation surface covering the opposing sheet 4 has been pushed so that the first electrode 11a and the second electrode 12a are moved closer to each other.

In this example, as shown in FIG. 9C, if the output difference is zero or the output difference is less than a predetermined threshold value as shown in FIG. 9D even though the electrostatic capacitance detected by the second electrode 12a increases, it may be determined that an object other than a finger has been used for pushing.

The input device 1 shown in FIGS. 1 and 2 may be configured such that the first input unit 10a, the second input unit 10b, the third input unit 10c and the fourth input unit 10d may be disposed in a cross shape, so that the input device can recognize the detection output when a finger comes into contact with the surface of any input unit and the detection output when any input unit is pushed by a finger by distinguishing therebetween. For example, by moving a finger which has come into contact with the surface of the first input unit 10a onto the surface of another input unit such as the surface of the third input unit 10c, an input signal for movement can be applied. In addition, by sequentially moving the finger 16, which has come into contact with the surface of the first input unit 10a, on the surfaces of the second input unit 10b, the third input unit 10c and the fourth input unit 10d, an input signal for rounding can be applied.

In addition, by detecting whether or not the opposing sheet 3 has been pushed by the finger 16 using all the input units 10a, 10b, 10c and 10d, a determination signal can be input. Also, by separately pushing the surfaces of the input units 10a, 10b, 10c and 10d, a signal can be also input such as a cross-shaped pressing switch.

When each of the input units 10a, 10b, 10c and 10d has been pushed by a finger, the detection output from the capacitance detection unit 30 may increase as shown in FIG. 8C. However, whether the detection output exceeds a predetermined threshold value is monitored, and when it exceeds the predetermined threshold value, it may be recognized that the input unit has been pushed, so that a switch signal may be output. In addition, according to the increase in detection output shown in FIG. 8C, how much pressure the input unit has been pressed with may be detected. In this case, in addition to the change in contact area of a finger with respect to the opposing sheet 4, the degree to which the first electrode 11a and the second electrode 12a have moved closer together can be detected.

Furthermore, while monitoring a difference between the change in electrostatic capacitance detected by the first electrode 11a and the change in electrostatic capacitance detected by the second electrode 12a, when the output difference is approximately zero or less than a predetermined threshold value as shown in FIG. 6D or FIG. 9D, the detection output may be ignored so as to be able to prevent an erroneous input when there has been no operation carried by a human finger. For example, even though any one of the input units 10a, 10b, 10c and 10d is erroneously pushed by a foreign body other than a finger when a portable apparatus is accommodated to a pocket or a bag, the output may be ignored so as to be able to prevent an erroneous input from being carried out.

FIG. 10 is a cross-sectional diagram illustrating the input device 110 according to an exempalry embodiment.

The input device 110 may be provided with a second electrode 112 on a support side of a hard substrate, and may be provided with a first electrode 111 on an operation side. The surface of the first electrode 111 may be covered with a flexible insulation sheet. On the lower side of the first electrode 111, a third electrode 113 may be provided, with a spacer sheet 114 interposed therebetween. An elastic sheet 108 may be interposed between the second electrode 112 and the third electrode 113.

When the insulation sheet on the surface has been pushed downward, a distance between the first electrode 111 and the third electrode 113 may not be changed, but a distance between the second electrode 112 and the third electrode 113 may be changed. The third electrode 113 may be set to approximately the ground potential.

As shown in FIG. 10, the capacitance detection unit 130A may detect the change in electrostatic capacitance on the basis of the change in potential or the change in current which may be obtained from the first electrode 111, and outputs the change as A data. The capacitance detection unit 130B may detect the change in electrostatic capacitance on the basis of the change in potential or the change in current which may be obtained from the second electrode 112, and may output the change as B data.

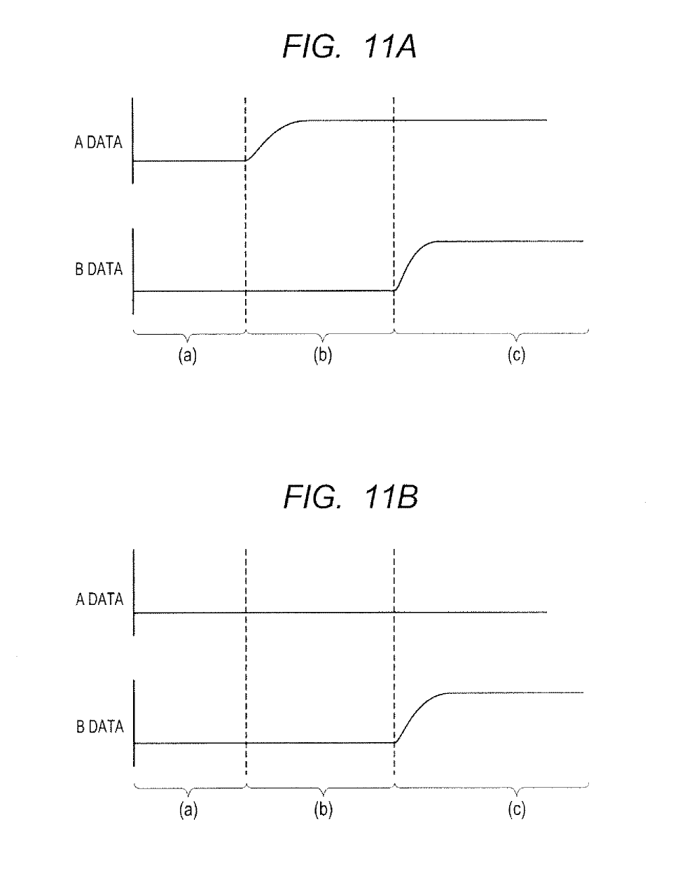

FIG. 11A illustrates the change in A data and B data when a human finger has come into contact with the surface of the insulation sheet and the first electrode 111 has been pushed downward by the finger. FIG. 11B illustrates the change in A data and B data when a non-conductive operation body has come into contact with the surface of the insulation sheet and the first electrode 111 has been pushed downward. The section (a) shown in FIGS. 11A and 11B corresponds to when no object has come into contact with the insulation sheet, the section (b) corresponds to when a finger or an operation body has come into contact with the surface of the sheet, and the section (c) corresponds to when the first electrode 111 has been pushed by a finger or an operation body.

When the operation is carried out by a human finger, the electrostatic capacitance between the first electrode 111 and the finger may increase, but a distance between the first electrode 111 and the third electrode 113 may not be changed. Therefore, in the A data shown in FIG. 11A, an increased amount of the electrostatic capacitance between the finger and the first electrode 111 may be detected in the section (b) and (c).

On the other hand, as the data A shown in FIG. 11B, even though a non-conductive operation body other than a finger has come into contact with and further presses the surface of the insulation sheet, the A data detected by the capacitance detection unit 130A may not be changed.

Next, in the B data shown in FIG. 11A, the change in electrostatic capacitance, such that the second electrode 112 and the third electrode 113 are moved closer to each other, may be detected in the section (c). At this time, even though a finger has come into contact with the surface of the first electrode 111, since the third electrode 113 is approximately the ground potential, the B data may not be affected. Therefore, in the section (c) shown in FIG. 11B, the change in B data when the first electrode 111 has been pushed by a non-conductive operation body other than a finger is the same as the change in D data shown in FIG. 11A.

In the input device 110 shown in FIGS. 10 and 11, by monitoring the B data, it can be detected whether or not the input unit has been pushed. In addition, by monitoring the output of the A data, it can be determined whether or not the operation is carried out by a finger or a non-conductive operation body other than a finger.

Further, in the structure shown in FIG. 10, the second electrode 112 is set to the ground potential and the change in potential or the change in current of the third electrode 113 is applied to the capacitance detection unit 130B so as to obtain the B data.

Further, the elastic sheet 8 shown in FIG. 2 may be provided at a portion in which the first electrode 11a and the second electrode 12a do not face each other, and there is air between the first electrode 11a and the second electrode 12a. In addition, the elastic sheet 8 may be formed of a domed elastic body, and there may be obtained a click feeling when the first electrode 11a has been pushed. This is also the same as that shown in FIG. 10.

Furthermore, the first electrode 11a may be a domed metallic electrode, and may be disposed so as to be insulated from the second electrode 12a.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input device comprising:
a first electrode which is positioned on a support side;
a second electrode which is positioned on an operation side so as to face the first electrode with a distance therebetween and which moves closer to the first electrode due to an operation pressure;
a first capacitance detection unit which detects a change in electrostatic capacitance from a change in potential or current of the second electrode when a human finger has been moved closer to the second electrode; and
a second capacitance detection unit which detects a change in electrostatic capacitance from a change in potential or current of the first electrode when the second electrode has been moved closer to the first electrode.

2. The input device according to claim 1,
wherein a common capacitance detection unit is commonly used as the first capacitance detection unit and the second capacitance detection unit; and
wherein the common capacitance detection unit is switched by a switching unit so as to be connected to the first electrode and the second electrode.

3. The input device according to claim 1,
wherein the capacitance detection unit includes:
an AND circuit which receives a pulse-shaped voltage on the one hand and receives the pulse-shaped voltage via a resistor and a variable condenser unit; and
a smoothing circuit which smoothes a waveform obtained from the AND circuit,
wherein the variable condenser unit is configured to be changed in capacitance by the change in potential or current of the first electrode or the second electrode.

4. The input device according to claim 1,
wherein when a human finger has been moved closer to the second electrode, a detection output of the first capacitance detection unit is changed and a detection output of the second capacitance detection unit is not substantially changed, and
wherein when the second electrode has been moved closer to the first electrode, a detection output of the first capacitance detection unit and a detection output of the second capacitance detection unit are changed together.

5. The input device according to claim 1,
wherein when the second electrode has been moved closer to the first electrode in a state where an operation body which is not a conductor has been moved closer to the second electrode, a difference between a detection output of the first capacitance detection unit and a detection output of the second capacitance detection unit is not substantially changed.

6. The input device according to claim 1,
wherein an elastic body is interposed between the first electrode and the second electrode.

7. The input device according to claim 6,
wherein the second electrode and the first electrode are formed on the same surface of an insulation substrate, and electrically conducted to each other via a conductive pattern in which an IC package including the second electrode, the first electrode and the capacitance detection unit is formed on the surface of the insulation substrate, and
wherein the insulation substrate is folded via the elastic body so as to make the second electrode face the first electrode.

8. An input device comprising:
a first electrode which is positioned on a support side;
a second electrode which is positioned on an operation side;
a third electrode which is not changed in distance from the second electrode and which moves closer to the first electrode when receiving an operation pressure,
a first capacitance detection unit which detects change in electrostatic capacitance from change in potential or current of the second electrode when a human finger has been moved closer to the second electrode; and
a second capacitance detection unit which detects change in electrostatic capacitance from change in potential or current of the first electrode or the third electrode when the third electrode has been moved closer to the first electrode.

9. The input device according to claim 8,
wherein the capacitance detection unit includes:
an AND circuit which receives a pulse-shaped voltage on the one hand and receives the pulse-shaped voltage via a resistor and a variable condenser unit; and
a smoothing circuit which smoothes a waveform obtained from the AND circuit,
wherein the variable condenser unit is configured to be changed in capacitance by the change in potential or current of the first electrode, the second electrode or the third electrode.

10. The input device according to claim 8,
wherein an elastic body is interposed between the first electrode and the third electrode.
